(19) United States
(12) Patent Application Publication
(10) Pub. No.: US 2008/0155051 A1
(43) Pub. Date: Jun. 26, 2008

(54) Direct file transfer system and method for a computer network

(75) Inventor: Mark Moshayedi, Newport Coast, CA (US)

Correspondence Address: SimpleTech, Inc., c/o S. Jalal Sadr, Esq., 3001 Daimler Street, Santa Ana, CA, 92705-5812, US

(73) Assignee: SimpleTech, Inc., Santa Ana, CA (US)

(21) Appl. No.: 11/644,691

(22) Filed: Dec. 23, 2006

(51) Int. Cl. G06F 15/167

(52) U.S. Cl. 709/213

(57) ABSTRACT

A computing host transfers a file between a computer network and a storage device without passing the file through a host processor of the computing host. A communication processor of the computing host receives a file request from the computer network and either processes the file request to directly transfer the file between the computer network and the storage device or passes the file request to the host processor for processing. Additionally, the communication processor writes the file into a cache memory and processes a subsequent file request on the file in the cache memory.

### CROSS-REFERENCE TO RELATED APPLICATIONS

The present invention is related to co-pending U.S. patent application Ser. No. ______, entitled “System and Method for Direct File Transfer in a Computer Network,” filed on even date herewith; co-pending U.S. patent application Ser. No. ______, entitled “Direct File Transfer Host Processor,” filed on even date herewith; and co-pending U.S. patent application Ser. No. ______, entitled “Direct File Transfer Communication Processor,” filed on even date herewith.

### BACKGROUND

1. Field of Invention

The present invention generally relates to computer networks. More particularly, the present invention relates to systems and methods of transferring a file in a computer network.

2. Description of Related Art

An ever-increasing amount of data is accessible over a computer network, such as the Internet, a local area network, or a wide area network. The data is typically stored in host servers, such as Web page servers, connected to the computer network. An increase in demand for data stored in such host servers has contributed to an increase of network traffic in computer networks and an increase in the resulting overhead in the host servers.

The overhead in a conventional host server involves generating data packets for a file in response to receiving a file request from a computer network. Typically, the host server reads the file from a storage device and stores the file into a memory of the host server. Once the file is in the memory, the host server segments the file into data portions and generates a header for each data portion. The host server then combines each data portion with the header of the data portion to generate a data packet including the data portion and the header. The host server then transmits the data packets to the computer network. Similarly, the host server receives data packets along with a file request from the computer network, constructs a file based on the data packets, and writes the file into the storage device. In addition to processing related to the overhead, the host server may execute applications on the data packets during construction of the file or on the constructed file.

An increase in overhead may cause a performance decrease in the host server. For example, the overhead of the host server may increase as a result of an increase in file requests received by the host server. Moreover, the increase in overhead may cause applications on the host server to execute more slowly. Consequently, the host server becomes a bottleneck in the flow of network traffic through the computer network, which may result in connection timeouts, poor quality media, or slow-loading Web pages.

In light of the above, a need exists for improving performance of a host server. A further need exists for reducing overhead in a host server.

### SUMMARY

In various embodiments, a computing host includes a host processor and a communication processor both coupled in communication with a network and a storage device. The communication processor receives a file request directed to the host processor for transferring a file between the network and the storage device. The communication processor determines whether the file request is to be performed by using a direct file transfer. If the communication processor determines that the file request is to be performed by using a direct file transfer, the communication processor transfers the file between the network and the storage device based on the file request without passing the file through the host processor. Otherwise, the communication processor provides the file request to the host processor, and the host processor transfers the file between the network and the storage device based on the file request. In this way, the file is directly transferred between the network and the storage device. Moreover, the overhead of the host processor is reduced and thus the performance of the host processor is increased.

A system for directly transferring a file between a network and a storage device in accordance with one embodiment, includes a filter module and a processing module. The filter module is configured to receive a file request directed to the host processor for transferring the file. The processing module is coupled to the filter module and is configured to transfer the file between the network and the storage device based on the file request without passing the file through the host processor.

A method for directly transferring a file between a network and a storage device, in accordance with one embodiment, includes receiving a first file request for transferring the file in the storage device. The file request is directed to a host processor coupled to the storage device. The method further includes transferring the file between the network and the storage device based on the first file request without passing the file through the host processor.

A system for directly transferring a file between a network and a storage device, in accordance with one embodiment, includes a means for receiving a file request directed to a host processor for transferring the file. The system further includes a means for transferring the file between the network and the storage device based on the file request without passing the file through the host processor.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a block diagram of a computing host, in accordance with an embodiment of the present invention;

FIG. 2 is a block diagram of a communication processor, in accordance with an embodiment of the present invention;

FIG. 3 is a block diagram of a processing engine, in accordance with an embodiment of the present invention;

FIG. 4 is a block diagram of a processing module, in accordance with an embodiment of the present invention;

FIG. 5 is a block diagram of a host processor, in accordance with an embodiment of the present invention;

FIG. 6 is a block diagram of a file address table, in accordance with an embodiment of the present invention;

FIG. 7 is a flow chart of a portion of a method of directly transferring a file between a network and a storage device, in accordance with an embodiment of the present invention; and

FIG. 8 is a flow chart of another portion of the method of directly transferring a file between a network and a storage device, in accordance with an embodiment of the present invention.

### DESCRIPTION

In various embodiments, a computing host receives a file request directed to a host processor of the computing host for transferring a file between a network and a storage device. A communication processor of the computing host determines the file is to be transferred between the network and the storage device by using a direct file transfer, and transfers the file between the network and storage device without passing the file through the host processor.

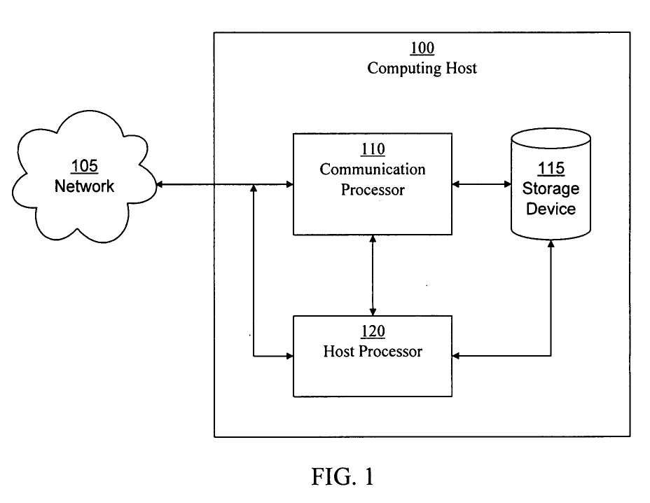

FIG. 1 illustrates a computing host 100, in accordance with an embodiment of the present invention. The computing host 100 includes a communication processor 110, a storage device 115, and a host processor 120. The communication processor 110 is coupled in communication with a network 105, the storage device 115, and the host processor 120. The host processor 120 is coupled in communication with the storage device 115 and may also be coupled in communication with the network 105.

The network 105 may include a local area network (LAN), a wide area network (WAN), a wireless network, the Internet, a cellular network, a wireless data transmission system, a two-way cable system, a customized computer network, an interactive kiosk network, a satellite network, a broadband network, a baseband network, a computer system or server, or the like, as well as any combination thereof. The communication processor 110 may include hardware or software, or both, for communicating with the network 105 or the storage device 115. Moreover, the communication processor 110 may communicate with any number of input/output (I/O) devices, systems, or networks. For example, the communication processor 110 may communicate with multiple storage devices 115 or multiple networks 105, or both. The storage device 115 may include any computing device, hardware, or software, for storing data. For example, the storage device 115 may include a redundant array of inexpensive disks (RAID), a storage area network (SAN), a small computer system interface (SCSI) disk, a disk drive, a solid-state drive, a flash memory, a flash storage array, a solid-state memory, a flash storage device, or the like. The storage device 115 may include several computer storage devices, which may be the same type of computer storage device or a combination of different types of computer storage devices.

The host processor 120 includes a computing device such as, for example, a network server, a server system, a mainframe computer, a personal computer, or the like. In one embodiment, the host processor 120 comprises a Web server including a computer program for serving Hypertext Markup Language (HTML) pages or files requested by client systems in the network 105. In another embodiment, the host processor 120 receives media requests from client systems in the network 105 and provides media content to the client systems in response to the media requests. The host processor 120 may include various types of program logic to control operation of the host processor 120. The program logic may include hardware or software components, such as object-oriented software components, class components, task components, processes, methods, functions, attributes, procedures, subroutines, program code segments, drivers, firmware, microcode, algorithms, techniques, programs, applications, data, databases, data structures, tables, arrays, variables, or the like.

The communication processor 110 may include any device, component, or software that manages or facilitates the transfer of data between the network 105 and the storage device 115. The communication processor 110 receives a file request from the network 105 for transferring a file between the network 105 and the storage device 115 and determines whether the file request is to be performed by using a direct file transfer, as is described more fully herein. For example, a file may be a data file, a program file, an executable file, an object file, a control file, a portion of a file, multiple files, a data structure, a data stream, data blocks, data bytes, data bits, or the like. If the file request is to be performed by using a direct file transfer, the host processor 120 generates a command based on the file request and provides the command to the communication processor 110. If the file request is to be performed by using a direct file transfer, the communication processor 110 transfers the file in the storage device 115 without passing the file through the host processor 120. In this way, the file is directly transferred in the storage device 115. A file request may be a read request or a write request. The communication processor 110 processes a read request by reading a file in the storage device 115 and providing the file to the network 105. The communication processor 110 processes a write request by receiving a file from the network 105 and writing the file into the storage device 115.

If the communication processor 110 determines that the file request is not to be performed by using a direct file transfer, the communication processor 110 provides the file request to the host processor 120. In response to receiving the file request, the host processor 120 transfers the file in the storage device 115 based on the file request. The host processor 120 processes a read request by reading the file in the storage device 115 and providing the file to the network 105. The host processor 120 processes a write request by receiving the file from the network 105 and writing the file into the storage device 115. In one embodiment, the host processor 120 reads the file in the storage device 115 and provides the file to the communication processor 110. In turn, the communication processor 110 receives the file from the host processor 120 and provides the file to the network 105. In another embodiment, the communication processor 10 receives the file of the file request from the network 105 and provides the file to the host processor 120. In turn, the host processor 120 receives the file from the communication processor 110 and writes the file into the storage device 115. In addition to transferring the file in the storage device 115 based on the file request, the host processor 120 may also process the file, for example by executing a computing process, such as a computing application, on the file.

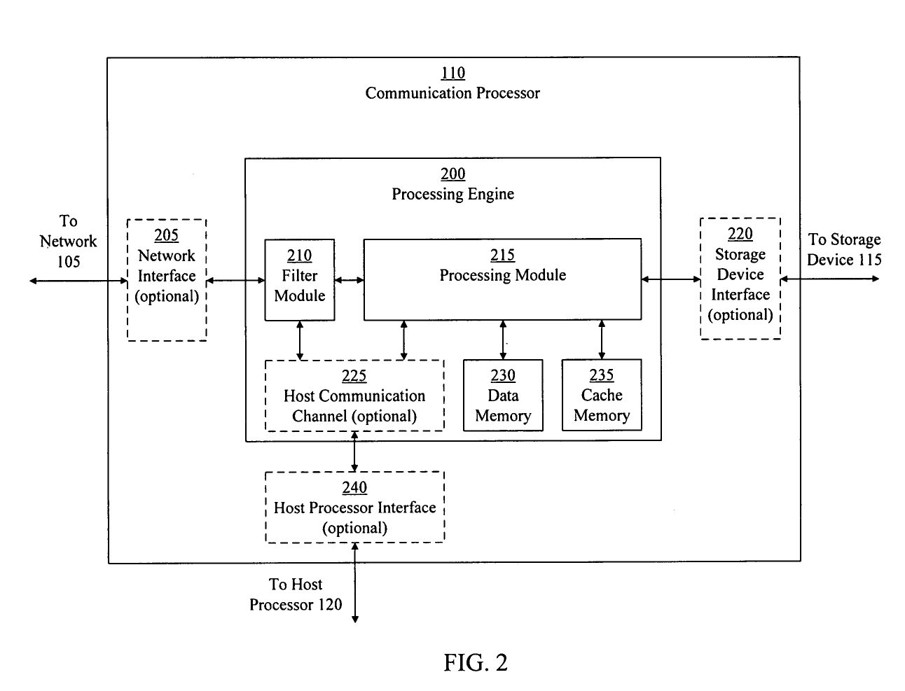

FIG. 2 illustrates the communication processor 110, in accordance with an embodiment of the present invention. The communication processor 110 includes a processing engine 200 coupled in communication with the network 105, the storage device 115, and the host processor 120. The processing engine 200 includes a filter module 210, a processing module 215, a data memory 230, and a cache memory 235. The filter module 210 is coupled in communication with the network 105, the processing module 215, and the host processor 120. The processing module 215 is coupled in communication with the data memory 230, the cache memory 235, the storage device 115, and the host processor 120.

The processing module 215 reads or writes data, including computing instructions, in the data memory 230, and the data memory 230 stores the data. Also, the processing module 215 reads or writes files, or portions thereof, in the cache memory 235, and the cache memory 235 stores the files or portions thereof. The processing module 215 may be a microprocessor, a microcontroller, an embedded processor, a logic circuit, or the like, or may include any combination thereof. Each of the data memory 230 and the cache memory 235 may be any memory, computing device, or system capable of storing data. For example, the data memory 230 or the cache memory 235, or both, may be a random transfer memory (RAM), a dynamic random transfer memory (DRAM), a static random transfer memory (SRAM), a synchronous dynamic random transfer memory (SDRAM), a read-only-memory (ROM), a programmable ROM (PROM), an erasable programmable ROM (EPROM), an electrically erasable programmable ROM (EEPROM), or the like. The cache memory 235 may be a direct-mapped cache memory, a set-associative cache memory, a fully-associative cache memory, or any other type of cache memory. In some embodiments, the data memory 230 or the cache memory 235, or both, are external of the processing engine 200. In some embodiments, the data memory 230 and the cache memory 235 may be combined.

In one embodiment, the processing module 215 stores a file identified in a file request received by the processing module 215 into the cache memory 235. Alternatively, the processing module 215 stores a portion of the file into the cache memory 235. The processing module 215 manages the cache memory 235 by using a cache algorithm. For example, the processing module 215 executes computing instructions based on the cache algorithm to manage the cache memory 235. In one embodiment, the processing module 215 writes the file of the most recent file request, or a portion of the file, into the cache memory 235, which may in some cases overwrite another file or portion thereof previously written into the cache memory 235.

The filter module 210 may include any device, system, or computing instructions capable of analyzing a file request received from the network 105 to determine whether the file request is to be processed by the processing module 215 or the host processor 120. The filter module 210 provides the file request to the processing module 215 or the host processor 120 based on that determination. The filter module 210 analyzes the network protocol of the file request to determine whether to provide the file request to the processing module 215 or the host processor 120. In one embodiment, the file request is a data packet, such as a TCP/IP or Ethernet packet. In this embodiment, the filter module 210 also analyzes other data packets associated with the file request and provides the data packets to the processing module 215 or the host processor 120, as is appropriate. For example, the filter module 210 may identify data packets for the file of the file request and provide the data packets to the processing module 215 for direct transfer of a file in the storage device 115 or to the host processor 120 for further processing, as is described more fully herein.

In one embodiment, the filter module 210 also processes the file request before providing the file request to the processing module 215 or the host processor 120. The filter module 210 processes the file request by removing or inserting headers or control information, such as control headers, in the file request. In various embodiments, the filter module 210 may also perform other functions, such as logging data, decrypting or encrypting data associated with the file request, or providing notification of the file request to the processing module 215 or the host processor 120. Although one filter module 210 is shown in FIG. 2, the communication processor 110 may have more than one filter module 210 in other embodiments. In various embodiments, some or all of the functions performed by the filter module 210 may be performed by other components of the communication processor 110 instead of the filter module 210.

In one embodiment, the filter module 210 determines whether the file request is to be performed by using a direct file transfer by determining whether the file request is a server file request or a storage file request. A server file request generally refers to a file request that requires significant computation or processing in addition to transferring a file in the storage device 115. A storage file request generally refers to a file request that does not require signification computation or processing in addition to transferring a file in the storage device 115. The filter module 210 determines, based on the file request, whether the file request is a server file request or a storage file request. In one embodiment, the filter module 210 identifies a computing process, such as a computing application, to be performed on a file based on a file request. The filter module 210 then determines whether the computing process is to be performed by the processing module 215 or the host processor 120. If the computing process is to be performed by the processing module 215, the file request is determined to be a storage file request. If the computing process is to be performed by the host processor 120, the computing process is determined to be a server file request.

In one embodiment, the filter module 210 maintains a data structure, such as a list or a table, identifying those computing processes that are to be performed in processing storage file requests. This data structure may be either internal or external of the filter module 210, or both. After the filter module 210 identifies a computing process to be performed in processing a file request, the filter module 210 determines, based on the data structure, whether the file request is a server file request or a storage file request. If the identified computing process is in the data structure, the filter module 210 determines that the file request is a storage file request. Otherwise, if the identified computing process is not in the data structure, the filter module 210 determines that the file request is a server file request. Thus, a file request is by default a server file request unless the filter module 210 determines based on the file request and the data structure that the file request is a storage file request. If the filter module 210 determines that the file request is a storage file request, the processing module 215 processes the file request. Otherwise, the filter module 210 passes the file request to the host processor 120 for further processing. In some embodiments, the filter module 210 may return an error message in response to receiving the file request. For example, the filter module 210 may return an error message if one or more data packets in the file request are corrupt or if a file to be transferred based on the file request is not in the cache memory 235 or the storage device 115. In other embodiments, the filter module 210 may ignore the storage file request, or pass the storage file request to the host processor 120 for processing as a server file request.

An example of a server file request is a network user login process in which the host processor 120 performs an authorization, authentication, and accounting (AAA) based on the file request. Other examples of server file requests include an initial request to transfer a Web page in the storage device 115 or a request to perform a storage system control process for controlling interaction between the host processor 120 and the storage device 115. Still another example of a server file request is a request to execute an application program on a file. Examples of storage file requests include requests for transferring media content in the storage device 115, such as a Joint Photographic Experts Group (JPEG) file, a windows audio file (WAV), a Moving Picture Experts Group Level-3 (MP3) file, a Moving Picture Experts Group (MPEG) file, or any other type of file, or the like. Other examples of storage file requests include requests for transferring data, such as reading or writing files, between the network 105 and the storage device 115.

The processing module 215 receives a file request from or through the filter module 210 and transfers a file in the storage device 115 based on the file request. The file request may be a write request for writing a file into the storage device 115 or a read request for reading a file from the storage device 115. If the file request is a write request, the processing module 215 receives data packets associated with the file request from or through the filter module 210, constructs a file based on the data packets, and writes the file into the storage device 115. For example, the data packets may be TCP/IP packets. Generally, each of the data packets includes a header and a data payload. In contrast to the data payload, the header includes control or routing information for the data packet, such as a destination address in the network 105. In the process of constructing the file, the processing module 215 identifies data payloads in the data packets and writes the data payloads into the data memory 230 or the cache memory 235. The processing module 215 then reads the file from the data memory 230 or the cache memory 235 and writes the file into the storage device 115. Alternatively, the processing module 215 writes the data payloads into the storage device 115 without first writing the data payloads into the data memory 230 or the cache memory 235.

If the file request is a read file request, the processing module 215 transfers the file in the storage device 115, generates one or more data packets based on the file, and provides the data packets to the filter module 210. In turn, the filter module 210 receives the data packets from the processing module 215 and provides the data packets to the network 105. In an alternative embodiment, the processing module 215 transfers the file in the storage device 115 and provides the data packets to the network 105, thus bypassing the filter module 210.

The processing engine 200 may also include an optional host communication channel 225 coupled in communication with the filter module 210, the processing module 215, and the host processor 120. The host communication channel 225 may include any computer device, system, or software, or any combination thereof, that facilitates communications between the processing engine 200 and the host processor 120. In one embodiment, the host communication channel 225 allows a local area network (LAN) in the processing engine 200 to communicate with a LAN in the host processor 120. The LANs in the processing engine 200 and the host processor 120 may use the same network protocol, such as an Ethernet protocol or token ring protocol, to communicate with each other through the host communication channel 225. In another embodiment, the host communication channel 225 is protocol independent.

Example communications that flow through the host communication channel 225 include, but are not limited to, protocols used to encode data; authorization authentication, and accounting (AAA) information; commands; requests; request-fulfilled commands (e.g., acknowledgements); file information; file names; and file locations. In one embodiment, the host communication channel 225 remains active or open throughout an operation, such as a file transfer operation. In other embodiments, the processing engine 200 or the host processor 120 disables or deactivates the host communication channel 225 when communication is not needed between the processing engine 200 and the host processor 120.

The host communication channel 225 may include a system bus, such as a Peripheral Component Interconnect (PCI) bus, a PCI 2.0x bus, a PCI-X bus, an Industry Standard Architecture (ISA) bus, a Micro Channel Architecture (MCA) bus, an Extended Industry Standard Architecture (EISA) bus, a Fibre Channel bus, or the like. In other embodiments, the host communication channel 225 may include other types of technology for coupling or connecting a computer system to another computer system. The host communication channel 225 may be internal, external, partially internal or partially external of the processing engine 200 in various embodiments.

In one embodiment, the host communication channel 225 has a dedicated channel number, such as a port number or a communication address, for coordinating communication between the processing engine 200 and the host processor 120. The host communication channel 225 selects the dedicated channel number when data, such as a file request or a data packet, is sent from the processing engine 200 through the host communication channel 225 to the host processor 120. Alternatively, the processing engine 200 selects the dedicated channel number before providing data, such as a file request or a data packet, to the host communication channel 225. In one embodiment, the designated channel number selected in the host communication channel 225 for a file request remains fixed during processing of the file request. In another embodiment, the designated channel number may be a variable address that changes according to requirements of the host processor 120 and the processing engine 200 during processing of the file request. In an embodiment including multiple processing engines 200 and multiple host communication channels 225, each host communication channel 225 may have a unique channel number for facilitating communication between a corresponding processing engine 200 and the host processor 120.

The communication processor 110 may include an optional network interface 205 coupled in communication with the network 105 and the processing engine 200. As shown in FIG. 2, the network interface 205 is coupled in communication with the filter module 210 of the processing engine 200. The network interface 205 facilitates communications between the network 105 and the filter module 210. In one embodiment, the network interface 205 includes a network interface card, such as a Gigabit Ethernet Network Interface Card (GbE NIC). In another embodiment, the network interface 205 includes a Network Interface Module (NIM). In still another embodiment, the network interface 205 includes software for facilitating communication between the network 105 and the processing engine 200. For example, the network interface 205 may include a Network Interface Device Driver (NIDD) for retrieving data packets from a receiving buffer in the NIM and distributing the data packets to the processing engine 200 or the host processor 120, as is appropriate. In one embodiment, the NIDD provides data packets having a supported protocol, such as an Internet Protocol (IP), to the processing module 215 for further processing. In this embodiment, the NIDD provides data packets having a non-supported protocol to the host processor 120.

The communication processor 110 may include an optional storage device interface 220 coupled in communication with the processing engine 200 and the storage device 115. As shown in FIG. 2, the storage device interface 220 is coupled in communication with the processing module 215 of the processing engine 200. The storage device interface 220 facilitates communications between the processing engine 200 and the storage device 115. The storage device interface 220 may include any device capable of coupling or connecting the processing engine 200 to one or more storage devices 115. For example, the storage device interface 220 may include a Small Computer Systems Interface (SCSI), an Integrated Drive Electronics (IDE) interface, an Advanced Technology Attachment (ATA) interface, a Fibre Channel interface, a flash storage interface, a solid-state storage device interface, a USB interface, or the like.

In embodiments with the storage device interface 220, the processing module 215 transfers a file in the storage device 115 through the storage device interface 220. The processing module 215 transfers the file in the storage device 115 by reading the file in the storage device 115 through the storage device interface 220 or by writing the file into the storage device 115 through the storage device interface 220.

The communication processor 110 may include an optional host processor interface 240 coupled in communication with the processing engine 200 and the host processor 120. As shown in FIG. 2, the host processor interface 240 is coupled in communication with the host communication channel 225 of the processing engine 200. The host processor interface 240 may include any device, system, software, interconnect technology, or device interface that enables the processing engine 200 to communicate with the host processor 120. In embodiments with the host processor interface 240, the filter module 210 receives a file request from the network 105 and provides the file request to the host processor 120 through the host processor interface 240. In one embodiment, the host processor interface 240 includes a system bus, such as a Peripheral Component Interconnect (PCI) bus, an Industry Standard Architecture (ISA) bus, a Micro Channel Architecture (MCA) bus, an Extended Industry Standard Architecture (EISA) bus, a Fibre Channel bus, or the like. For example, the system bus may be a PCI 2.0x bus or a PCI-X bus.

In one embodiment, the host processor 120 includes application programs that enable the host processor 120 to communicate with the processing engine 200 through the host processor interface 240. For example, the application programs may include plug-and-play technology which establishes a communication channel between the processing engine 200 and the host processor 120 upon connection of the communication processor 110 to the host processor 120 through the host processor interface 240.

In one embodiment, the host processor 120 does not initially include the appropriate applications or programs for enabling communication between the host processor 120 and the communication processor 110 through the host processor interface 240. In this embodiment, program logic may be added to the host processor 120 for enabling the host processor 120 to communicate with the communication processor 110 through the host processor interface 240. Such program logic may be transparent, or introduce minimal changes, to the host processor 120 or applications in the host processor 120. In one embodiment, the program logic is a computer program installed on the host processor 120 before the host processor 120 is connected to the host processor interface 240. The program logic may be tailored for a given computing platform of the host processor 120.

In one embodiment, the host processor interface 240 facilitates different types of communications between the communication processor 110 and the host processor 120. Examples of communications between the communication processor 110 and the host processor 120 include protocol for encoding data; authorization, authentication, and accounting (AAA) information; commands; requests; request-fulfilled commands; and file information, such as the names or locations of files, and the like. The communications between the communication processor 110 and the host processor 120 may be based on a communication protocol or may be independent of a communication protocol. In one embodiment, the host processor interface 240 remains active or open throughout the operation of the communication processor 110 and the host processor 120. In other embodiments, the host processor interface 240 may be deactivated or disabled, for example when communication is not needed between the communication processor 110 and the host processor 120.

In various embodiments, each of the network interface 205, the storage device interface 220, and the host processor interface 240 may be internal, external, partially internal, or partially external of the communication processor 110. Moreover, in some embodiments, the communication processor 110 may operate without one or more of the network interface 205, the storage device interface 220, or the host processor interface 240. In other embodiments, the communication processor 110 may operate with multiple network interfaces 205, multiple storage device interfaces 220, or multiple host processor interfaces 240. For example, the communication processor 110 may operate with two storage devices 115 through two corresponding storage device interfaces 220.

In some embodiments, the network interface 205, the storage device interface 220, or the host processor interface 240, or any combination thereof, includes one or more data buffers to synchronize or accommodate transmission of communications with the communication processor 110. For example, the communication processor 110 may communicate with the network 105 through the network interface 205 using an Ethernet protocol, an asynchronous transfer mode (ATM) protocol, a synchronous optical network (SONET) protocol, or the like, in which data in the communication is stored in a data buffer. As another example, the communication processor 110 may communicate with the storage device 115 through the storage device interface 220 or with the host processor 120 through the host processor interface 240 by using a Small Computer Systems Interconnect (SCSI) protocol, and Internet SCSI (iSCSI) protocol, a Fiber Channel protocol, a Peripheral Component Interconnect (PCI) protocol, an InfiniBand protocol, a USB protocol, a flash storage connection, or the like.

In one embodiment, the communication processor 110 includes speed-matching technology for transferring data between the network 105 and the storage device 115. For example, the speed-matching technology may include data buffers for matching a communication data rate of the network 105 to a communication data rate of the storage device 115. In another embodiment, the communication processor 110 includes load-balancing technology for controlling the flow of communications between the communication processor 110 and the network 105, the storage device 115, or the host processor 120, or any combination thereof. The communication processor 110 communicates with the network 105, the storage device 115, or the host processor 120 to perform load-balancing. For example, the communication processor 110 prioritizes communications between the communication processor 110 and the network 105, the storage device 115, or the host processor 120, or any combination thereof. In one embodiment, the communication processor 110 prioritizes communications to provide a quality of service (QoS) for communications. A quality of service of the communications may involve providing different priorities to different communications or to different elements of the communication processor 110, or guaranteeing a certain level of performance to a communication. For example, the communication processor 10 may give communications containing media content a higher priority than other communications not containing media content.

In various embodiments, the communication processor 10 may be implemented as one of the following: a local area network (LAN) interface; a network interface card (NIC); an Ethernet NIC; a storage host bus adapter (HBA); a Small Computer System Interface (SCSI) HBA; a Fibre Channel HBA; a hardware accelerator; a software accelerator; a network protocol offload device; a storage protocol offload device; a network protocol accelerator; a storage protocol accelerator; a protocol engine; a Transmission Control Protocol/Internet Protocol (TCP/IP) offload device; a TCP/IP offload engine (TOE); a transport protocol offload device; an Internet Small Computer System Interface (iSCSI); an Internet Protocol; a SCSI protocol; an iSCSI protocol; an iSCSI initiator program; an iSCSI target driver; an iSCSI target program; a direct attached storage (DAS) device; a block service; a file service; a cache memory; a network attached storage (NAS) device; a computer program; a digital media; a digital media device; a streaming media server; a Real-Time Protocol (RTP); a Real-Time Control Protocol (RTCP); a Real-Time Streaming Protocol (RTSP); a hypertext transfer protocol (HTTP) offload device; an HTTP accelerator; a flash storage device or system; a solid-state storage device; a USB device; or the like.

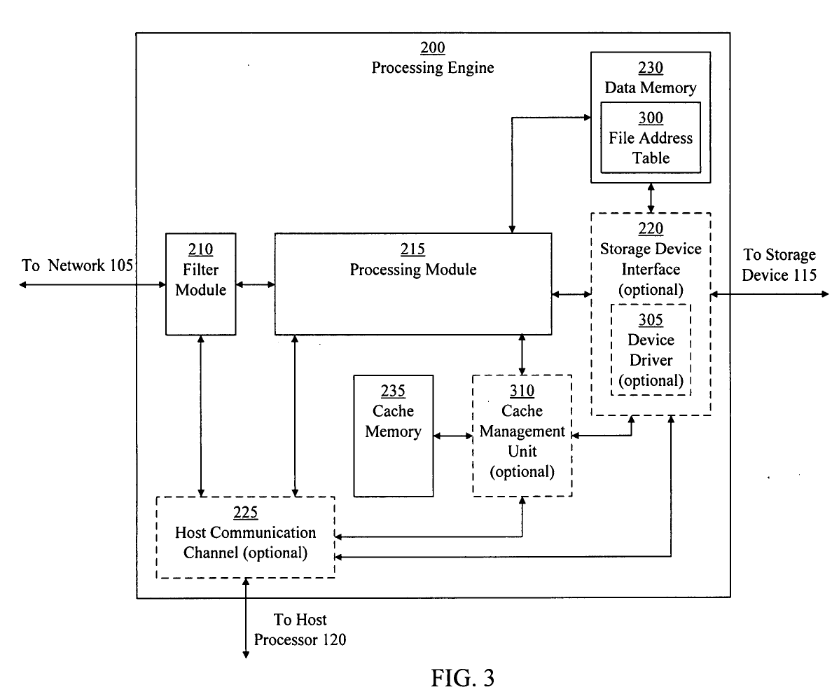

FIG. 3 illustrates the processing engine 200, in accordance with one embodiment. The processing engine 200 includes the filter module 210, the processing module 215, the storage device interface 220, the data memory 230, and the cache memory 235. The filter module 210 is coupled in communication with the network 105, the processing module 215, and the host processor 120. The processing module 215 is coupled in communication with the data memory 230, the cache memory 235, the storage device 115, and the host processor 120. The storage device interface 220 is coupled in communication with the storage device 115 and may also be coupled in communication with the data memory 230 or the cache memory 235, or both. In some embodiments, the storage device interface 220 may be external of the processing engine 200. The processing engine 200 may include the optional host communication channel 225. In embodiments including the host communication channel 225, the host communication channel 225 is coupled in communication with the host processor 120, the filter module 210, and the processing module 215. Additionally, the host communication channel 225 may be coupled in communication with the cache memory 235 or the storage device interface 220, or both.

The processing engine 200 may also include a cache management unit 310 coupled in communication with the processing module 215 and the cache memory 235. The cache management unit 310 may be any device, system or program logic for managing data stored in the cache memory 235. In one embodiment, the host processor 120 is coupled in communication with the cache management unit 310 through the host communication channel 225 and transfers data in the cache memory 235 through the cache management unit 310. In another embodiment, the storage device interface 220 is coupled in communication with the cache management unit 310 and transfers data in the cache memory 235 through the cache management unit 310. In addition to managing data in the cache memory 235, the cache management unit 310 also controls transfer to the cache memory 235 from the processing module 215, the storage device interface 220, the host processor 120, or any combination thereof.

The processing engine 200 includes a file address table 300 for identifying locations of files in the computing host 100. The file address table 300 may be any device, system, computing instructions, program logic, data structure, software, or the like. For example, the file address table 300 may include, or reside on, a random transfer memory. The processing module 215 transfers the file address table 300 to identify the location of a file in the computing host 100 or to write the location of the file into the file address table 300. The location of the file may be a memory address in the storage device 115 or the cache memory 235. In some embodiments, the storage device interface 220 or the host processor 120, or both, may also transfer the file address table 300. The file address table 300 may be a data structure, such as a data structure defined in a high-level computing language. For example, the file address table 300 may be a linked list data structure. In one embodiment, the file address table 300 is stored in the data memory 230. In other embodiments, the file address table 300 may be external of the data memory 230.

In one embodiment, the processing module 215 searches the file address table 300 to determine the location of the file. The processing module 215 may search the file address table 300 by using a search technique and search criteria. For example, the processing module 215 may use perform a linear search or an index search based on a file name or other file identifier of the file.

The storage device interface 220 may include a device driver 305 for facilitating communication between the storage device 115 and the processing module 215. The device driver 305 may include software or firmware contained in the storage device interface 220. In some embodiments, the device driver 305 also facilitates communication between the storage device 115 and the cache memory 235. For example, the device driver 305 may facilitate the transfer of a file between the storage device 115 and the cache memory 235. Further, the device driver 305 determines the location of the file by transferring the file address table 300 in the data memory 230. In various embodiments, the device driver 305 is optional.

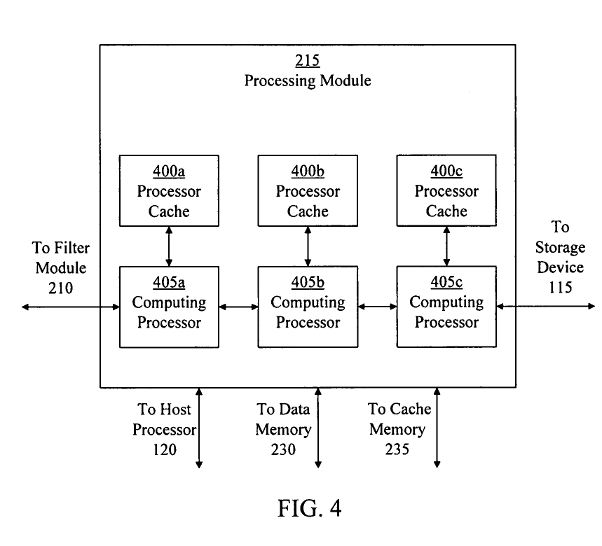

FIG. 4 illustrates the processing module 215, in accordance with one embodiment. The processing module 215 includes one or more computing processors 405, each of which is coupled in communication with a corresponding processor cache 400. As shown in the illustration, the processing module 215 includes three computing processors 405a-c coupled in communication with three corresponding processor caches 400a-c. In other embodiments, the processing module 215 may include more or fewer computing processors 405 or processor cache 400.

In one embodiment, the computing processors 405 are data-driven and arranged in a pipeline. As shown in FIG. 4, the computing processor 405a is coupled in communication with the filter module 210 and the computing processor 405b. The computing processor 405c is coupled in communication with the computing processor 405b and the storage device 115. In this data-driven pipeline, each of the computing processors 405 initiates a computing task in response to receiving data and then outputs data computed as a result of the computing task. In one embodiment, each of the computing processors 405 includes an input queue or buffer for receiving data. In this embodiment, a computing processor 405 receives data into the input queue from another computing processor 405 in the pipeline. The computing processor 405 then performs a computing task on the data in the input queue in the order the data is received in the input queue. Moreover, the computing processors 405 asynchronously perform processing tasks on data as the data passes through the pipeline.

The computing processor 405 may be any device or system that processes computing instructions. For example, the computing processor 405 may be a Reduced Instruction Set Computing (RISC) processor, an Advanced RISC (ARC) processor, a Complex Instruction Set Computer (CISC) processor, or the like. The processor cache 400 associated with the computing processor 405 stores data for the computing processor 405. In one embodiment, the processor cache 400 is on a same device, such as a computer chip, as the corresponding computing processor 405. In this embodiment, the processor cache 400 is often referred to as a level one (L1) cache memory. In another embodiment, the processor cache 400 is on a computer chip separate from a computing chip containing the associated computing processor 405. In this embodiment, the processor cache 400 is often referred to as a level two (L2) cache memory. In some embodiments, the computing processor 405 may use more than one processor cache 400. In some embodiments, multiple computing processors 405 may use the same processor cache 400.

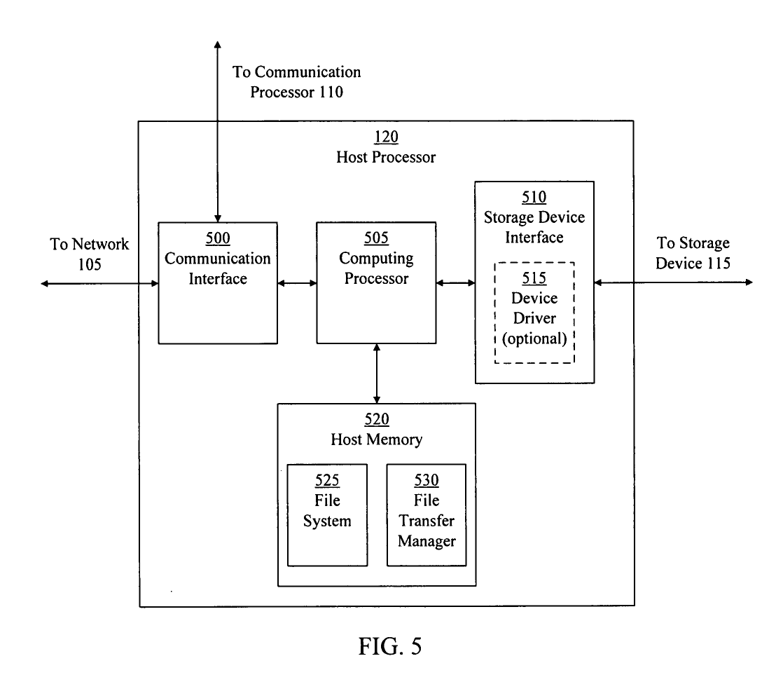

FIG. 5 illustrates the host processor 120, in accordance with an embodiment of the present invention. The host processor 120 includes a communication interface 500, a computing processor 505, a storage device interface 510, and a host memory 520. The communication interface 500 is coupled in communication with the communication processor 110 and the computing processor 505, and facilitates communication between the communication processor 110 and the computing processor 505. Additionally, the communication interface 500 may be coupled in communication with the network 105 for facilitating communication between the network 105 and the computing processor 505. The computing processor 505 may be a microprocessor, a microcontroller, a controller, an embedded controller, a logic circuit, or the like.

The storage device interface 510 is coupled in communication with the computing processor 505 and the storage device 115, and facilitates communication between the computing processor 505 and the storage device 115. In one embodiment, the storage device interface 510 includes an optional device driver 515 for facilitating communication between the computing processor 505 and the storage device 115. For example, the device driver 515 may be software or firmware in the storage device interface 510. In one embodiment, the device driver 515 includes a dynamic link library (DLL) file. In some embodiments, the device driver 515 may be external of the storage device interface 510.

The host memory 520 is coupled in communication with the computing processor 505 and stores data, such as computing instructions, for the computing processor 505. The host memory 520 may be any device or system capable of storing data. For example, the host memory 520 may include a dynamic random transfer memory (DRAM), a synchronous dynamic random transfer memory (SDRAM), a static random transfer memory (SRAM), a read-only memory (ROM), a programmable ROM (PROM), an electrically erasable programmable ROM (EEPROM), an erasable programmable ROM (EPROM), a flash memory, a flash storage, or the like. In some embodiments, the computing processor 505 includes the host memory 520.

The host memory 520 further includes a file system 525 and a file transfer manager 530. The file system 525 may include any device, system, or computer instructions for organizing files for storage in, and retrieval from, the storage device 115. In one embodiment, the file system 525 includes a computer file system for managing files. The computer file system may include any device, system, software, or algorithms by which files are named, identified, or organized for storage and retrieval. For example, the file system 525 may organize files in directories having a hierarchical or tree structure and may include a convention for naming the files. The file system 525 may also include a format for specifying a path to a file in the directory structure. In one embodiment, the file system 525 is a Linux-based file system, and in another embodiment, the file system 525 is a Windows-based file system. In one embodiment, the file system 525 is stored in the host memory 520 as illustrated in FIG. 5. In this embodiment, the computing processor 505 executes the file system 525 to manage the files in the storage device 115. For example, the file system 525 may be a software program or include computing processes.

The file transfer manager 530 identifies a file in the storage device 115 based on the file system 525 and a file request received by the host processor 120. The file transfer manager 530 may include any device, system, computing instructions, or algorithm for identifying a file in the storage device 115. In one embodiment, the file transfer manager 530 identifies an address of a file based on the file system 525 and a file request. The computing processor 505 transfers the file in the storage device 115 based on the address of the file. Alternatively, if the file is in the cache memory 235, the computing processor 505 transfers the file in the cache memory 235. Additionally, the file transfer manager 530 provides the address of the file to the communication processor 110. The communication processor 110 transfers the file in the storage device 115 based on the address of the file. Alternatively, if the file is in the cache memory 235, the communication processor 110 transfers the file in the cache memory 235.

In one embodiment, the file transfer manager 530 is a software program stored in the host memory 520 as illustrated in FIG. 5. In this embodiment, the computing processor 505 executes the file transfer manager 530 to identify an address of a file based on a file request and the file system 525. The computing processor 505 then transfers the file identified by the address in the storage device 115. Alternatively, the computing processor 505 provides the address of the file to the communication processor 110, and the communication processor 110 transfers the file at the address in the storage device 115. In one embodiment, the file transfer manager 530 communicates with the device driver 515 to transfer the file in the storage device 115.

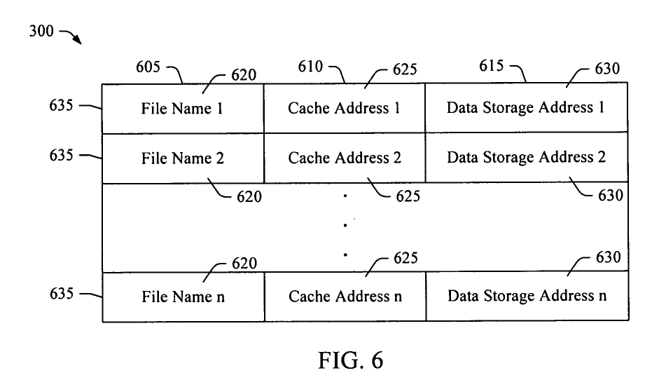

FIG. 6 illustrates the file address table 300, in accordance with an embodiment of the present invention. The file address table 300 includes a file name column 605, a cache address column 610, and a data storage address column 615. The file name column 605 may store a file name 620 of a file stored in the storage device 115. The file name column 605 may also store a file name 620 of a file to be stored in the storage device 115. A file name 620 in the file name column 605 may be an identifier of a file, such as an alphabetic, alphanumeric, symbolic, numeric, or hexadecimal identifier of the file.

The cache address column 610 may store a cache address 625 for a file having a file name 620 in the file name column 605. The cache address 625 for the file is associated with the file name 620 of the file and identifies a location of the file in the cache memory 235. Although the cache address 625 identifies a location of the associated file in the cache memory 235, the cache address 625 may instead indicate that the file is not stored in the cache memory 235. For example, the cache address 625 may be a value, such as a null value or an error value, indicating that the file is not in the cache memory 235. The cache address 625 may be any identifier of a location in the cache memory 235, such as an alphabetic, alphanumeric, symbolic, numeric, or hexadecimal representation of an address in the cache memory 235. Other examples of the cache address 625 include an address offset or a pointer to an address.

The data storage address column 615 may store a data storage address 630 for a file having a file name 620 in the file name column 605. The data storage address 630 for the file is associated with the file name 620 and may identify a location of the file in the storage device 115. Although the data storage address 630 may identify a location of the associated file in the storage device 115, the data storage address 630 may instead indicate that the file is not stored in the storage device 115. For example, the data storage address 630 may be a value, such as a null value or an error value, indicating that the file is not in the storage device 115. The data storage address 630 may be any identifier of a location in the storage device 115, such as an alphabetic, alphanumeric, symbolic, numeric, or hexadecimal representation of an address in the storage device 115. Other examples of the data storage address 630 include an address offset or a pointer to an address.

The file address table 300 may contain any number of rows 635, each of which includes a file name 620 in the file name column 605. The file name 620 may be any type of identifier for identifying a file. The file address table 300 may include a cache address 625 in the cache address column 610 or a data storage address 630 in the data storage address column 615, or both. In each row 635, the file name 620 may be associated with a cache address 625 or a data storage address 630, or both, in the row 635. In some situations, the file address table 300 may contain no rows 635. For example, the file address table 300 may contain no rows 635 after initialization of the communication processor 110, which may occur during a purge, loss of power, or the like.

In another embodiment, the file address table 300 may contain multiple cache addresses 625 or multiple data storage addresses 630 associated with a single file. For example, the file address table 300 may contain multiple data storage addresses 630, each of which identifies the location of a portion of a file or a mirror/copy of the file in the storage device 115. The multiple data storage addresses 630 associated with the file may be sequential data storage addresses 630 or non-sequential data storage addresses 630. The file address table 300 may contain multiple cache addresses 625, each of which identifies the location of a portion of a file in the cache memory 235.

In one embodiment, the processing engine 200 includes a file address table 300 for the cache memory 235 and a separate file address table 300 for the storage device 115. In this embodiment, the file address table 300 for the cache memory 235 has a file name column 605 and a cache address column 610, and the file address table 300 for the storage device 115 has a file name column 605 and a data storage address column 615. The file address table 300 may be any data structure for storing file names and file addresses. For example, the file address table 300 for either the cache memory 235 or the storage device 115 may be a file descriptor table, a linked list, or the like.

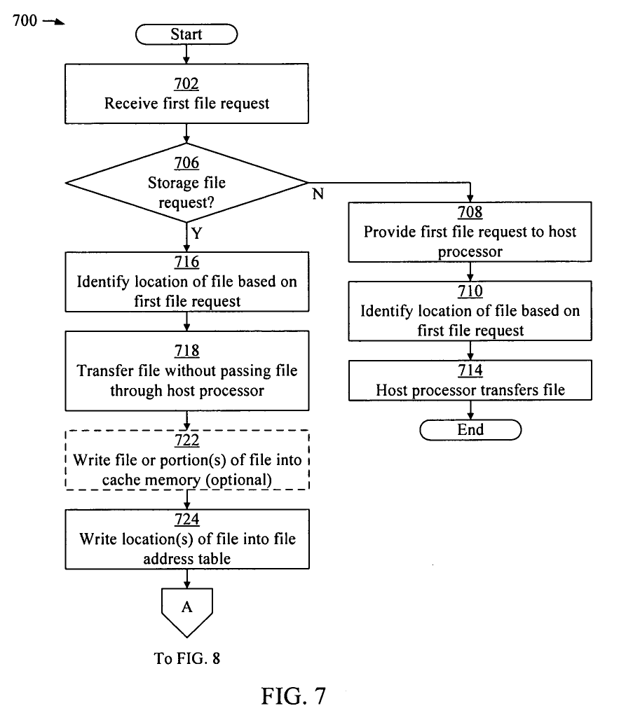

FIG. 7 is a flow chart of a portion of a method 700 of directly transferring a file between a network and a storage device, in accordance with an embodiment of the present invention. In step 702, the communication processor 110 receives a first file request from a requesting device. The first file request is directed to the host processor 120. For example, the first file request may include an address, such as an Internet Protocol address, identifying the host processor 120 as a destination of the first file request. The first file request may be issued to the network 105 by the requesting device for delivery to the host processor 120. In one embodiment, the filter module 210 of the communication processor 110 receives the first file request from the network 105. In another embodiment, the network interface 205 of the communication processor 110 receives the first file request from the network 105 and provides the first file request to the filter module 210. In this embodiment, the filter module 210 receives the first file request from the network 105 through the network interface 205. The method 700 then proceeds to step 706.

In step 706, the communication processor 110 determines whether the first file request is a storage file request. In one embodiment, the filter module 210 of the communication processor determines whether the first file request is a storage file request or a server file request by identifying a computing process, such as a computing application, to be performed on a file based on the first file request. The filter module 210 then determines based on the computing application whether the first file request is a storage file request or a server file request. The filter module 210 maintains a data structure, such as a list or a table, or an algorithm or a process, for identifying computing processes that are to be performed by storage file requests and other computing processes that are to be performed by server file requests. If the first file request is not a storage file request, the method 700 proceeds to step 708, otherwise the method 700 proceeds to step 716.

In step 708, arrived at from the determination in step 706 that the first file request is not a storage file request, the communication processor 110 provides the first file request to the host processor 120. In one embodiment, the filter module 210 of the communication processor 110 provides the first file request to the host processor 120. In embodiments including the host communication channel 225, the filer module 210 provides the first file request to the host processor 120 through the host communication channel 225. In embodiments including the host processor interface 240, the filter module 210 provides the first file request to the host processor 120 through the host processor interface 240. The method 700 then proceeds to step 710.

In step 710, the host processor 120 identifies a location of the file in the storage device 115 based on the first file request. For example, the location of the file in the storage device 115 may be a data storage address 630. In one embodiment, the computing processor 505 of the host processor 120 identifies a file name based on the first file request. The computing processor 505 then utilizes the file transfer manager 530 to identify the location of the file in the storage device 115 based on the file name. In this process, the file transfer manager 530 queries the file system 525 to determine the location of the file in the storage device 115. The method 700 then proceeds to step 714.

In step 714, the host processor 120 transfers the file between the network 105 and the storage device 115. If the first file request is a read request, the host processor 120 transfers the file in the storage device 115 by reading the file from the storage device 115. The host processor 120 then provides the file to the network 105 for delivery to the requesting device that issued the first file request. If the first file request is a write request, the host processor 120 transfers the file in the storage device 115 by writing the file into the storage device 115. In this process, the filter module 210 receives the file associated with the first file request from the network 105, and provides the file to the host processor 120. For example, the filter module 210 receives data packets comprising the file from the network 105 and provides the data packets to the host processor 120. The host processor 120 receives the file from the filter module 210 and stores the file into the storage device 115. The method 700 then ends.

In step 716, arrived at from the determination in step 706 that the first file request is a storage file request, the processing module 215 identifies a location of the file based on the first file request. For example, the location of the file in the storage device 115 may be a data storage address 630. In one embodiment, the processing module 215 identifies the location of the file by identifying a file name based on the first file request and sending an address request containing the file name to the computing processor 505 of the host processor 120. In response to receiving the address request, the computing processor 505 then executes the file transfer manager 530 based on the file name to identify the location of the file in the storage device 115. The computing processor 505 then provides the location of the file in the storage device 115 to the processing module 215.

In a further embodiment, the processing module 215 provides a confirmation to the computing processor 505 indicating that the processing module 215 received the location of the file in the storage device 115. In response to the confirmation received from the processing module 215, the computing processor 505 provides a command to the processing module 215 for transferring the file in the storage device 115. The method 700 then proceeds to step 718

In step 718, the processing module 215 transfers the file between the network 105 and the storage device 115 without passing the file through the host processor 120. If the first file request is a read request, the processing module 215 transfers the file in the storage device 115 by reading the file from the storage device 115. The processing module 215 then provides the file to the filter module 210, and the filter module 210 transmits (e.g., sends) the file to the network 105 for delivery to the requesting device. If the first file request is a write request, the processing module 215 transfers the file in the storage device 115 by writing the file into the storage device 115. In this process, the filter module 210 receives the file associated with the first file request from the network 105, and provides the file to the processing module 215. For example, the filter module 210 receives data packets comprising the file from the network 105 and provides the data packets to the processing module 215. The processing module 215 receives the file from the filter module 210 and stores the file into the storage device 115. The method 700 then proceeds to step 722.

In optional step 722, the processing module 215 writes the file, or a portion of the file, into the cache memory 235 at one or more locations in the cache memory 235. The locations in the cache memory 235 may be cache addresses 625. The file may include multiple portions, and the processing module 215 may selectively write some of the portions of the file into the cache memory 235. For example, the processing module 215 may select a portion of the file based on a size or location of the portion. The method 700 then proceeds to step 724.

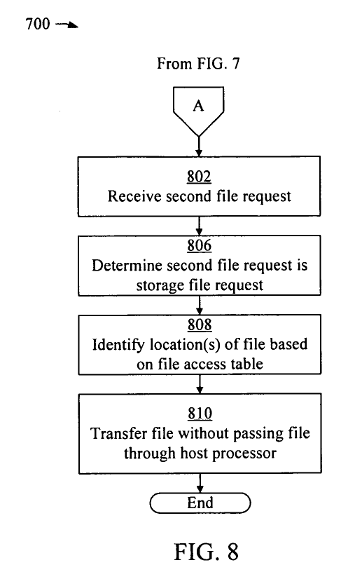

In step 724, the processing module 215 writes the location of the file, or locations of portions of the file, into the file address table 300. The locations of portions of the file may include a location of a portion of the file in the cache memory 235, a location of a portion of the file in the storage device 115, or both. The location of the file or a portion of the file in the cache memory 235 may be a cache address 625. The location of the file or a portion of the file in the storage device 115 may be a data storage address 630. The method 700 then proceeds to step 802 of FIG. 8. In other embodiments, step 724 may be performed before step 722 or at the same time as step 722.

FIG. 8 is a flow chart of another portion of the method 700 of directly transferring the file between the network and the storage device, in accordance with an embodiment of the present invention. In step 802, arrived at from step 724 of FIG. 7, the host processor 120 receives a second file request from the requesting device. In one embodiment, the filter module 210 receives the second file request from the network 105. In another embodiment, the network interface 205 receives the second file request from the network 105 and provides the second file request to the filter module 210. In this embodiment, the filter module 210 receives the second file request from the network 105 through the network interface 205. The method 700 then proceeds to step 806.

In step 806, the filter module 210 determines the second file request is a storage file request. In one embodiment, the filter module 210 determines the second file request is a storage file request by identifying a computing process to be performed on the file based on the second file request and determining that the computing process is to be performed by the processing module 215. The method 700 then proceeds to step 808.

In step 808, the processing module 215 identifies the location of the file, or locations of corresponding portions of the file, based on the file address table 300. For example, the location of the file, or the location of a portion of the file, may be a cache address 625 or a data storage address 630. In one embodiment, the processing module 215 identifies a file name 620 of the file based on the second file request. The processing module 215 then identifies the location of the file, or the location of a portion of the file, by identifying a cache address 625 or a data storage address 630 associated with the file name in the file address table 300.

In a further embodiment, the processing module 215 communicates with the host processor 120 to determine whether the location of the file in the file address table 300 is valid. For example, the location of the file in the file address table 300 may become invalid if the file has been modified, the format of the storage device 115 has changed, the file is relocated in the storage device 115, a portion of the file is overwritten, or the like. If the processing module 215 determines that the location of the file in the file address table 300 is invalid, the processing module 215 communicates with the host processor 120 to determine a valid location for the file and writes the address of the valid location into the file address table 300 to replace the invalid location.

In another further embodiment, the processing module 215 generates or provides an error message, or a similar indication of an error, if the file is not in the cache memory 235 or the storage device 115. The processing module 215 provides the error message to the filter module 210. In turn, the filter module 210 provides the error message to the network 105 for delivery to a requesting device that issued the second file request.

In step 810, the processing module 215 transfers the file between the network 105 and the storage device 115 without passing the file through the host processor 120. If the location of the file is a cache address 625, the processing module 215 accesses the file in the cache memory 235 at the cache address 625. If the location of the file is a data storage address 630, the processing module 215 accesses the file in the storage device 115 at the data storage address 630. If the location of a first portion of the file is a cache address 625 and the location of a second portion of the file is a data storage address 630, the processing module 215 accesses the first portion of the file in the cache memory 235 at the cache address 625 and accesses the second portion of the file in the storage device 115 at the data storage address 630.

The processing module 215 accesses the file in the cache memory 235 by writing the file into the cache memory 235 or by reading the file from the cache memory 235. The processing module 215 accesses the file in the storage device 115 by writing the file into the storage device 115 or by reading the file from the storage device 115. Additionally, if the second file request is a read request, the processing module 215 provides the file to the filter module 210 and the filter module 210 provides the file to the network 105 for delivery to the requesting device that issued the second file request. The method 700 then ends.

The steps of the method 700 may be performed in an order different from the order described above with reference to FIGS. 7 and 8. In some embodiments, the method 700 may include more or fewer steps than those shown in FIGS. 7 and 8. In other embodiments, some of the steps shown in FIG. 7 or 8 may be combined into a single step or carried out substantially simultaneously.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A system for directly transferring a file between a network and a storage device, the system comprising:
a filter module configured to receive a first file request for transferring the file, the first file request being directed to a host processor coupled to the storage device; and
a processing module coupled to the filter module and the storage device, the processing module configured to transfer the file in the storage device based on the first file request without passing the file through the host processor.

2. The system of claim 1, wherein the filter module is further configured to determine whether the first file request is a storage file request.

3. The system of claim 1, further comprising a file transfer manager configured to identify a location of the file in the storage device, the processing module further configured to access the file at the location of the file in the storage device.

4. The system of claim 3, further comprising a file address table, the processing module further configured to write the location of the file in the storage device into the file address table.

5. The system of claim 4, wherein the filter module is further configured to receive a second file request for transferring the file, and wherein the processing module is further configured to identify the location of the file in the storage device based on the file address table and the second file request, and to access the file at the location of the file in the storage device based on the second file request.

6. The system of claim 4, further comprising a cache memory, wherein the processing module is further configured to write the file into the cache memory at a location in the cache memory and to write the location of the file in the cache memory into the file address table.

7. The system of claim 6, wherein the filter module is further configured to receive a second file request for transferring the file, and wherein the processing module is further configured to identify the location of the file in the cache memory based on the file address table and the second file request and to access the file at the location of the file in the cache memory based on the second file request.

8. The system of claim 4, further comprising a cache memory, wherein the file comprises a first portion and a second portion, the processing module is further configured to write the first portion of the file into the cache memory at a location in the cache memory and to write the location of the first portion of the file in the cache memory into the file address table, the file transfer manager is further configure to identify a location of the second portion of the file in the storage device, and the processing module is further configured to write the location of the second portion of the file in the storage device into the file address table.

9. The system of claim 8, wherein the processing module is further configured to receive a second file request for transferring the file, identify both the location of the first portion of the file in the cache memory and the location of the second portion of the file in storage device based on the file address table and the second file request, access the first portion of the file in the cache memory at the location of the file in the cache memory based on the second file request, and access the second portion of the file in the storage device at the location of the second portion of the file in the storage device based on the second file request.

10. A method for directly transferring a file between a network and a storage device, the method comprising:
receiving a first file request for transferring the file in the storage device, the file request being directed to a host processor coupled to the storage device; and
transferring the file between the network and the storage device based on the first file request without passing the file through the host processor.

11. The method of claim 10, further comprising determining whether the first file request is a storage file request.

12. The method of claim 10, further comprising identifying a location of the file in the storage device, wherein transferring the file between the network and the storage device based on the first file request without passing the file through the host processor comprises accessing the file at the location of the file in the storage device.

13. The method of claim 12, further comprising writing the location of the file in the storage device into a file address table.

14. The method of claim 13, further comprising:
receiving a second file request for transferring the file;
identifying the location of the file in the storage device based on the file address table and the second file request; and
accessing the file at the location of the file in the storage device based on the second file request.

15. The method of claim 13, further comprising:
writing the file into a cache memory at a location in the cache memory; and
writing the location of the file in the cache memory into the file address table.

16. The method of claim 15, further comprising:
receiving a second file request for transferring the file;
identifying the location of the file in the cache memory based on the file address table and the second file request; and
accessing the file in the cache memory at the location of the file in the cache memory based on the second file request.

17. The method of claim 13, further comprising:
writing a first portion of the file into the cache memory at a location in the cache memory;
writing the location of the first portion of the file in the cache memory into the file address table;
identifying a location of a second portion of the file in the storage device; and
writing the location of the second portion of the file in the storage device into the file address table.

18. The method of claim 17, further comprising:
receiving a second file request for transferring the file;
identifying the location of the first portion of the file in the cache memory based on the file address table and the second file request;
identifying the location of the second portion of the file in the storage device based on the file address table and the second file request;
accessing the first portion of the file in the cache memory at the location of the first portion of the file in the cache memory based on the second file request; and
accessing the second portion of the file in the storage device at the location of the second portion of the file in the storage device based on the file request.

19. A system for directly transferring a file between a network and a storage device through a network, the system comprising:
means for receiving a file request for transferring the file, the file request being directed to a host processor coupled to the storage device; and
means for transferring the file between the network and the storage device based on the file request without passing the file through the host processor.

20. The system of claim 19, further comprising means for determining the file request is a storage file request.
